(19) United States
(12) Patent Application Publication
(10) Pub. No.: US 2014/0144121 A1
(43) Pub. Date: May 29, 2014

(54) GAS TURBINE ENGINE WITH BEARING OIL LEAK RECUPERATION SYSTEM

(71) Applicant: PRATT & WHITNEY CANADA CORP., Longueuil (CA)

(72) Inventors: Pierre-Yves Légaré, Chambly (CA); Alessandro CIAMPA, Montreal (CA); Michel Labbé, Montreal (CA)

(73) Assignee: PRATT & WHITNEY CANADA CORP., Longueuil (CA)

(21) Appl. No.: 13/687,511

(22) Filed: Nov. 28, 2012

(51) Int. Cl. F02C 7/06

(52) U.S. Cl. CPC F02C 7/06
USPC 60/39.08

(57) ABSTRACT

A gas turbine engine having an annular gas path between a radially outer wall and a radially inner wall, leading successively across at least one compressor stage, a combustor section, and at least one turbine stage, a hollow shaft having an internal surface with an oil trap formed therein, and at least one oil recuperation orifice extending out across the hollow shaft from the oil trap; and a bearing cavity formed within the radially inner wall, having at least one bearing therein rotatably supporting the hollow shaft of the gas turbine engine, at least two bearing seals enclosing the at least one bearing in the bearing cavity and separating the bearing cavity from associated buffer air entry points, at least a first one of said buffer air entry points being exposed to the at least one oil recuperation orifice outside the hollow shaft.

### TECHNICAL FIELD

The application relates generally to shaft bearing systems of gas turbine engines and, more particularly, to a system which can redirect oil.

### BACKGROUND

Buffer air flow reversal has been known to occur in some engine transient conditions. During flow reversal, bearing oil which is normally maintained into the bearing cavity by the greater buffer air pressure at the entry point, becomes instead entrained away from the bearing cavity by the bearing cavity pressure being higher than the buffer air pressure at the entry point.

If a deviation path is present providing fluid flow communication with the entry point and the gas path downstream of the combustor via an internal passage of a hollow shaft, the deviation path can carry leakage oil into internal cavities where it can ignite or into the exhaust stream which poses environmental issues, either of which are undesired. Accordingly, there remains room for improvement in addressing oil leakage into deviation paths of gas turbine engines.

### SUMMARY

In one aspect, there is provided a gas turbine engine having an annular gas path between a radially outer wall and a radially inner wall, leading successively across at least one compressor stage, a combustor section, and at least one turbine stage, the gas turbine engine comprising: a hollow shaft having a wall with an internal shaft cavity therein, the wall having an external surface and an internal surface having an oil trap terminated by an annular ridge protruding radially-inwardly, and at least one oil recuperation orifice extending there across and leading into the oil trap; a deviation path providing fluid flow communication between the internal shaft cavity and the gas path and being distinct from the oil recuperation orifice; a bearing cavity formed within the radially inner wall, having at least one bearing therein rotatably supporting the hollow shaft of the gas turbine engine, at least two bearing seals enclosing the at least one bearing in the bearing cavity and separating the bearing cavity from associated buffer air entry points, and at least one scavenge line inlet in the bearing cavity; an oil supply system including oil paths leading to each of the bearings; a buffer air supply system including buffer air paths leading to each of the entry points; at least a first one of said buffer air entry points being in fluid flow communication with the oil trap of the internal shaft cavity via the at least one oil recuperation orifice; whereby, during use, oil inside the internal shaft cavity can become trapped in the oil trap and prevented from entering the deviation path by centrifugal action imparted by the rotation of the hollow shaft, to re-enter the bearing cavity via the oil recuperation orifice and the first entry point.

In a second aspect, there is provided a gas turbine engine having an annular gas path between a radially outer wall and a radially inner wall, leading successively across at least one compressor stage, a combustor section, and at least one turbine stage, the gas turbine engine comprising : a hollow shaft having an internal surface with an oil trap formed therein, and at least one oil recuperation orifice extending out across the hollow shaft from the oil trap; and a bearing cavity formed within the radially inner wall, having at least one bearing therein rotatably supporting the hollow shaft of the gas turbine engine, at least two bearing seals enclosing the at least one bearing in the bearing cavity and separating the bearing cavity from associated buffer air entry points, at least a first one of said buffer air entry points being exposed to the at least one oil recuperation orifice outside the hollow shaft.

Further details of these and other aspects of the present invention will be apparent from the detailed description and figures included below.

### DESCRIPTION OF THE DRAWINGS

Reference is now made to the accompanying figures, in which:

FIG. 1 is a schematic cross-sectional view of a gas turbine engine;

FIG. 2 is a portion of FIG. 1 enlarged, showing a portion of the gas path upstream from a bleed aperture and combustor;

FIG. 3 is a portion of FIG. 2 enlarged, showing an entry point of buffer air to one of the bearings;

FIG. 4 is a portion of FIG. 2 enlarged, showing an occurrence of flow reversal at two bearings;

FIG. 5 is a portion of FIG. 2 enlarged, showing an occurrence of flow reversal at one bearing, and oil recuperation.

### DETAILED DESCRIPTION

As will be seen from the description below, an annular chamber referred to as an oil trap can be provided on an inside surface of a hollow shaft to trap oil which would enter into the hollow shaft in the event of a pressure reversal at an entry point. The annular chamber prevents oil from continuing its way along the hollow shaft, and rather allowing its recuperation into the bearing cavity and to the scavenge line, via apertures provided through the hollow shaft and leading to an entry point through a seal in which pressure is not reversed, or alternately, by accumulating the oil during the occurrence of pressure reversal to thereafter recuperate it through the same seal it exited once the pressure reversal is finished. The high velocity rotation of the hollow shaft causes centrifugal movement of the oil driving it against the internal surface.

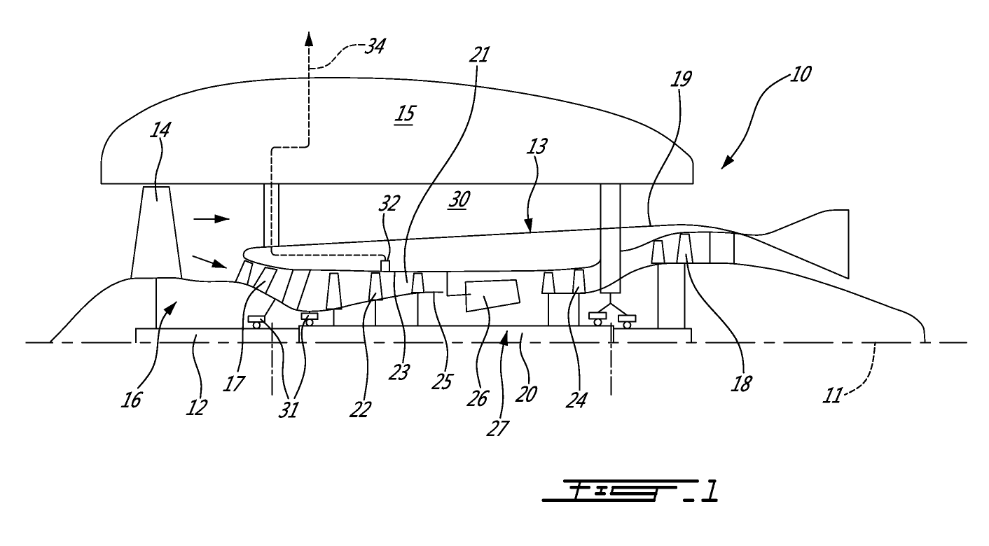

FIG. 1 shows an example of a turbofan gas turbine engine 10 which includes an annular bypass duct 15 housing an engine core 13. The engine core 13 is coaxially positioned within the annular bypass duct 15 and an annular bypass air passage 30 is defined radially therebetween for directing a bypass air flow driven by a fan assembly 14.

The engine core 13 has a non-rotary portion referred to herein as the core casing 19 which rotatably accommodates a low pressure spool assembly 16 which includes the fan assembly 14, a low pressure compressor assembly 17 for a first compressor stage, and a low pressure turbine assembly 18 for a second turbine stage, all interconnected by a first, inner shaft 12, and a high pressure spool assembly 27 which includes a high pressure compressor assembly 22 for a second compressor stage and a high pressure turbine assembly 24 for a first turbine stage, both interconnected by a second, outer shaft 20. The spools 16, 27, can independently rotate about a central axis 11 of the engine via their associated shafts 12, 20.

A gas path 21 is formed in the engine core 13. The gas path 21 splits from the bypass air passage 30 downstream of the fan 14 and channels a main flow sequentially through the compressor stages 17, 22 for pressurizing the air, a combustor 26 in which the compressed air is mixed with fuel and ignited for generating an annular stream of hot combustion gases, and turbine stages 24, 18 where energy is extracted from the combustion gases. The gas path 21 is formed between a radially-outer wall 23 and a radially-inner wall 25. The radially-outer wall 23 is formed in the core casing 19, whereas the radially-inner wall 25 is made continuous along the compressor and turbine stages both by non-rotating portions of the core casing 19 rotary portions of the spools 16, 27.

A bleed air aperture 32 can be formed in the radially-outer wall 23 of the gas path 21, upstream of the combustor 26, in the compressor stages 17, 22, to obtain pressurized air which can be carried along a bleed air path 34 and at least a portion of which can be used for pressurizing a cabin of the aircraft.

The rotating spool assemblies 16, 27, and more specifically the shafts 12, 20 thereof, are rotatably received in the non-rotating core casing 19 via bearings 31, two or more of which are on the inlet side and some of which are on the exhaust side relative the combustor 26.

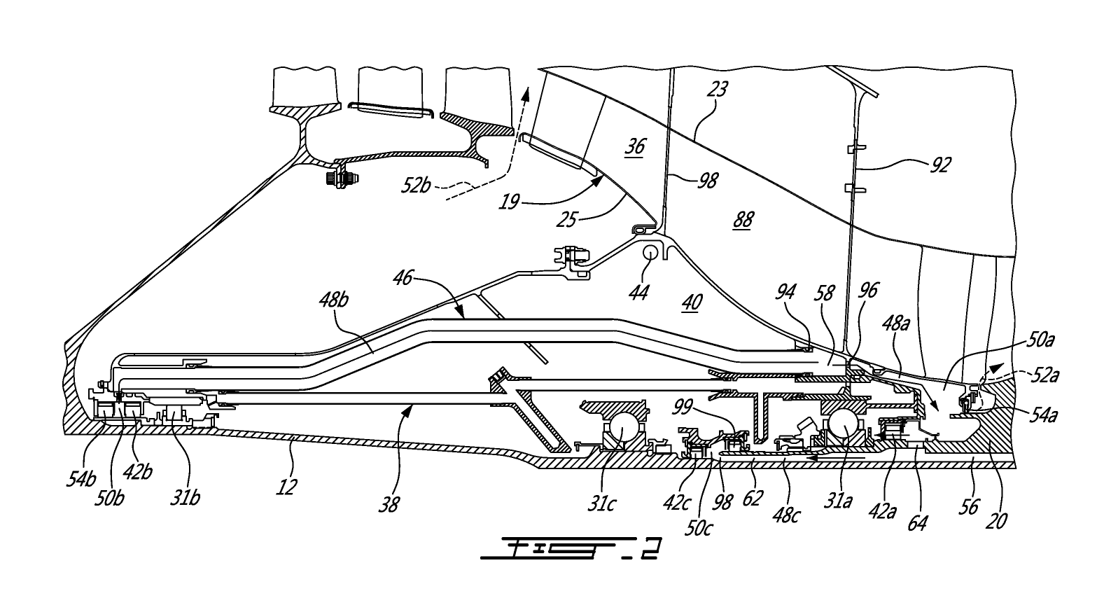

Referring to FIG. 2, which shows bearings 31a, 31b, 31c of the inlet side, or front side, and a portion of the gas path 36 upstream of the bleed aperture, it can be seen that in this particular embodiment, the gas turbine engine 10 has three bearings 31a, 31b, 31c rotatably receiving the inner shaft 12 and outer shaft 20 in a non-rotating portion of the core casing 19. Each one of the bearings 31a, 31b, 31c is continuously supplied with oil for lubrication and cooling. The oil is supplied by an oil supply system 38 which includes oil paths which can be formed by an oil tubing network branching off to each bearing 31a, 31b, 31c. During use, oil continuously spills from the bearings 31a, 31b, 31c as fresh oil is being fed.

A bearing cavity 40 is formed in the non-rotary portion of the core casing 19, within the radially-inner wall 25 of the gas path portion 36. The bearing cavity contains the bearings 31a, 31b, 31c. Gaps between the walls and/or structure of the bearing cavity 40 and the rotary shafts 12, 20 are sealed via corresponding bearing seals 42a, 42b, 42c associated to corresponding bearings 31a, 31b, 31c. A scavenge inlet 44 is provided in the bearing cavity 40, leading to a scavenge passage by which used oil can be removed from the bearing cavity.

A positive pressure system is set up in order to direct the used oil into the bearing cavity 40 from where it can be evacuated by the scavenge system. The positive pressure system includes a buffer air supply system 46 having buffer air paths 48a, 48b, 48c supplying pressurized air to entry points 50a, 50b, 50c associated with each bearing 31a, 31b, 31c. In this embodiment, the entry points 50a, 50b, 50c are in the form of cavities which are distinct and separated from the bearing cavity 40 and the corresponding bearings 31a, 31b, 31c by associated bearing seals 42a, 42b, 42c. Some of the entry points 50a, 50b are associated with secondary paths 52a, 52b leading to the gas path portion 36 which is upstream of the bleed air aperture, in which case the corresponding entry points 50a, 50b are separated from the secondary paths 52a, 52b by associated secondary seals 54a, 54b. Some of the entry points 50b, 50c are in fluid flow communication with a deviation path 56 which is partitioned from the gas path portion 36 upstream of the bleed air aperture. The deviation path 56 can, for example, lead back into the gas path 21 toward the rear of the engine, downstream from the combustor 26, and mix with the exhaust gasses. During normal use, the pressure of the buffer air is higher than the pressure in the bearing cavity 40 and therefore, the pressure at the entry points 50a, 50b, 50c can be maintained higher than the pressure in the cavity 40, in which case a flow of buffer air travels across the bearing seals 42a, 42b, 42c, and then across the bearings 31a, 31b, 31c carrying with it used oil into the bearing cavity 40.

The positive pressure system can work well without further features during normal use, as long as the buffer air pressure at the entry points 50a, 50b, 50c remains higher than the internal pressure of the bearing cavity 40.

However, some flight situations, such as transient conditions, can lead to pressure variations in the buffer air supply. If the buffer air pressure at any given entry point 50a, 50b, 50c becomes lower than the internal bearing cavity pressure, flow reversal across the associated bearing seal 42a, 42b, 42c occurs. During reversed flow, pressurized air from the bearing cavity 40 flows across the bearings 31a, 31b, 31c and associated bearing seals 42a, 42b, 42c into the entry point 50a, 50b, 50c contaminated with oil, and could eventually enter the secondary path 52b, 52a leading to the gas path portion 36. The bleed air could thus become contaminated with oil and be used in the cabin, and even a very minor oil contamination in the cabin air can render the cabin atmosphere very uncomfortable for any passengers—a highly undesirable scenario. However, means can be provided by which the likelihood of oil contamination in the gas path portion 36 upstream of the bleed air aperture can be reduced.

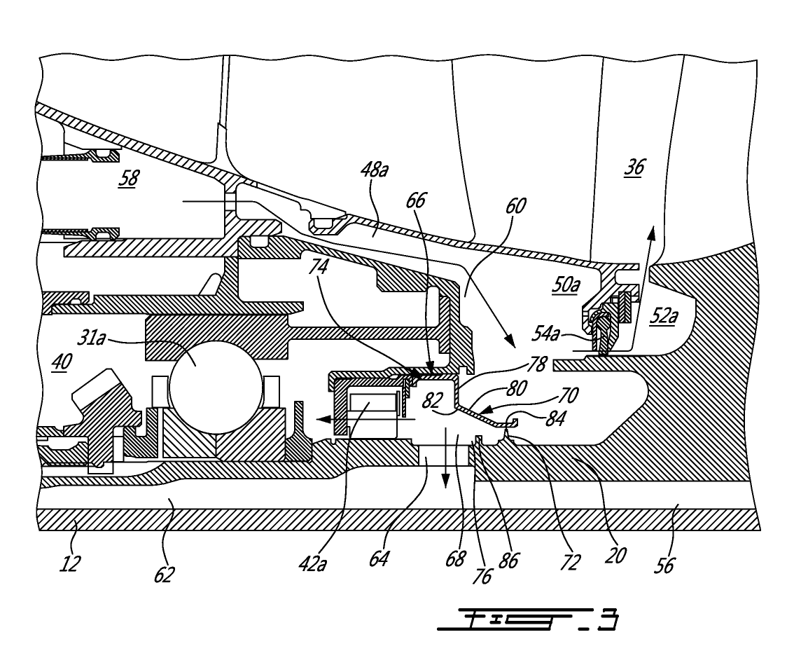

FIG. 3 shows the area of bearing 31a enlarged. An associated buffer air path 48a is formed between a plenum 58 leading to an associated entry point 50a. The entry point 50a is in the form of a cavity exposed to the associated bearing seal 42a, having an inlet 60 receiving the associated buffer air path 48a, being in fluid flow communication with the secondary path 52a via a secondary seal 54a, and being in fluid flow communication with the deviation path 56, provided in this example partially by way of a portion of the intershaft spacing 62, via an intershaft feed orifice 64. In this embodiment, the deviation path 56 is formed partially by a portion of the intershaft spacing 62 extending rearwardly from the intershaft feed orifice 64. The pressure of the entry point 50a is controlled to favour remaining higher than the pressure in the bearing cavity 40.

The presence of the intershaft feed orifice 64 leading to the intershaft spacing 62 in this example provides an alternate route to evacuate oil should oil flow reversal occur at the bearing seal 42a. As a guide to this end, a baffle arrangement 66 is used to separate a subchamber 68 from the remaining portion of the entry point 50a. More particularly, in this embodiment, the baffle arrangement 66 separates the subchamber 68, where the associated bearing seal 42a and intershaft feed orifice 64 are located, from the remainder of the entry point 50a where the seal 54a leading to the secondary path 52a is located. The baffle arrangement 66 is thus operational upon flow reversal to guide fluid coming into the subchamber 68 from the bearing seal 42a to the intershaft spacing 62 via the intershaft feed orifice 64, thereby guiding oil-contaminated fluid away from the secondary path 52a.

In this embodiment, the baffle arrangement 66 includes a non-rotating baffle 70 and a lab seal 72 formed in the rotary outer shaft 20 and oriented in opposition with the non-rotating baffle 70. Henceforth, in the event of flow reversal at the bearing seal 42a, a high velocity positive flow into the subchamber 68 from the remaining portion of the entry point 50a can be maintained across the lab seal 72, and the reversed flow is thus guided into the intershaft spacing 62 where the pressure is lower still, through the intershaft feed orifice 64. This can thus successfully prevent oil from reaching the gas path portion 36 upstream from the bleed air aperture in such an event of flow reversal, for instance.

In this particular embodiment, opposing outer gutter 74 and inner gutter 76 are further formed respectively by the baffle 70 and the outer shaft 20. More particularly, on the one hand, an annular outer gutter 74 shape is formed in the baffle 70 and has a radially-extending portion 78 connected to an adjacent sloping portion 80 by a corner 82, the sloping portion 80 leading to an axially oriented portion 84 positioned in opposition with the lab seal 72, and on the other hand, an annular inner gutter 76 shape is further formed in the outer shaft 20, partially by way of an outward annular projection 86 formed in the outer shaft 20 adjacent the lab seal 72, the outward annular projection 86 being radially aligned with the sloping portion 80 of the baffle 70. The opposing gutters 74, 76 serve to guide the oil during engine shutdown, preventing the oil from reaching the lab seal 72, from where it could potentially exit the subchamber 76 at the next start-up. More particularly, in the upper portion of the engine, when the engine axis is horizontal, oil adhering to the outer gutter 74 can drip off the corner 82 and fall in the inner gutter 76. Moreover, in the lower portion of the engine, oil in the inner gutter 76 can drip off the outward annular projection 86 and fall onto the sloping portion 80 of the baffle 70 which then slopes downwardly away from the lab seal 72, into the outer gutter 74. The external annular projection 86 can also serve as a splash guard to prevent splash from reaching the lab seal 72, such as in the event of oil dripping from the corner 82 of the baffle or flow reversal across seal 42a. The outward annular projection 86 is optional.

As detailed above, the issue of potential oil flow reversal through seal 42a at that bearing location can be satisfactorily addressed. However, on a given engine, not all bearing locations offer an alternate route to avoid the gas path portion 36 upstream of the bleed air aperture, and even if all bearing locations do offer a deviation path, it may be preferred to provide any required means to guide the reverse flow to the deviation path only at one or some of the bearing locations, such as for weight or cost considerations for instance. For example, in the embodiment shown in FIG. 2, the entry point 50b to bearing 31b has no alternate route, and pressure reversal there cannot be dealt with in the same manner as it is dealt with for bearing 31a.

However, the pressure at the entry points 50a, 50b, 50c can be independently controlled to force reversal to occur at a selected one of the entry points 50a, 50b, 50c for a given occurrence of buffer air pressure drop. For instance, the buffer air supply system 46 in FIG. 2 can be configured to bring a higher pressure of buffer air to a first entry point than to a second entry point, in a manner that if flow reversal occurs following a given buffer air pressure loss event, it can occur at the second entry point without occurring at the first. In this manner, the system can be configured for a flow reversal to preferably occur at an entry point where means are provided to deal with it and guide it to a deviation path.

Referring to FIG. 2, in this specific example, hollow struts 88 extending across the gas path portion 36 which are closed by a contour wall 90 except for an inlet at the outer end and an outlet 94 at the inner end, are used as a ducts for channelling buffer air across the gas path portion 36 during which the buffer air can loose heat to the gas path portion 36. Such a system is optional, but can be advantageous to potentially reduce cooling requirements in some embodiments. The outlets 94 of two or more struts 88 can be interconnected by a plenum 58 to offer a balanced pressure. The buffer air path then splits into one buffer air path 48b leading to the entry point 50b and another air path 48a leading to the entry point 50a.

In this specific embodiment, the buffer air flow to entry point 50a is restricted compared to the buffer air flow to entry point 50b by way of a flow restrictor 96 such as a smaller aperture area for instance. Therefore, flow of buffer air is favored to entry point 50b. Compared to one another, entry point 50b can be said to be a low pressure entry point and entry point 50a can be said to be a high pressure entry point. For a given pressure loss in the struts 88 and/or at the plenum 58, a flow reversal could thus occur at entry point 50a where the pressure is lesser and where it can be dealt with to avoid contamination of cabin air, without occurring at entry point 50b where the pressure is higher, assuming that the pressure across the bearing cavity 40 is constant.

Still referring to FIG. 2, it will be noted that in an embodiment such as the one illustrated having two shafts 12, 20 and an intershaft spacing 62, a gap 98 can be present between the tip of the outer shaft 20 and the inner shaft 12. In this particular example, this gap 98 is sealed from the bearing cavity 40 by two seals, including bearing seal 42c leading to the bearing cavity 40 across bearing 31c, and a seal 99. The entry point 50c to both these seals is pressurized via the entry point 50a, along connecting path 48c extending along a portion of the intershaft spacing 62 from the intershaft feed orifice 64.

The location of this bearing 31c and associated bearing seal 42c is such that it has a natural fluid flow communication toward the deviation path 56 successively via the gap 98 and a portion of the intershaft spacing 62 forward of the intershaft feed orifice 64. Furthermore, it does not have an independent secondary path leading to the gas path portion 36 upstream from the bleed aperture. Henceforth, bearing seal 42c can be a location of preferred flow reversal even over bearing seal 42a. In this particular embodiment, the buffer air supply system 46 is configured for pressure to be lower at entry point 50c than at entry point 50a, which is achieved by the use of a flow restrictor in the connecting path 48c, such as can be provided by a restricted area of intershaft feed orifice 64 for instance. In this sense, when compared to one another, entry point 50c can be said to be a low pressure entry point whereas entry point 50a can be said to be a high pressure entry point. Upon flow reversal at bearing seal 42c, oil-contaminated fluid can evacuate toward the aft of the engine via the intershaft spacing 62.

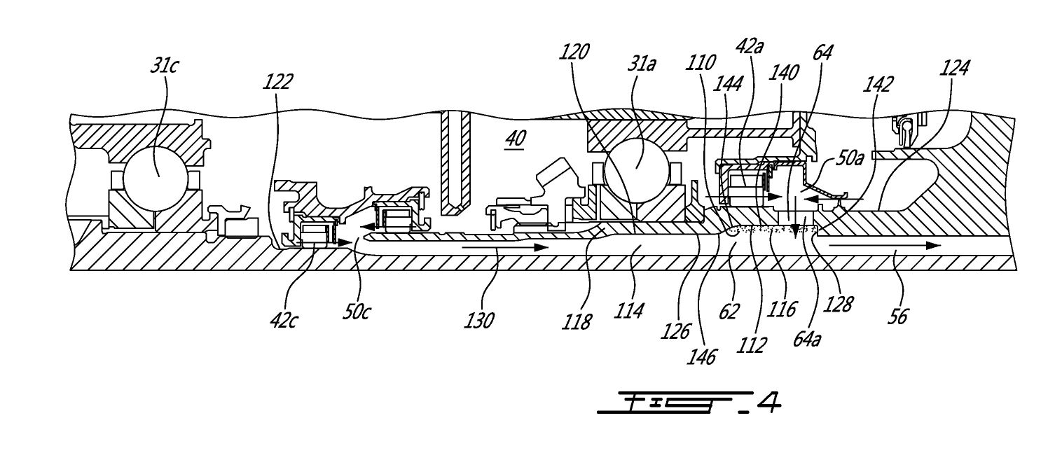

In an embodiment with two shafts 12, 20 such as illustrated, and where the pressure is controlled to be lower at entry point 50c than at entry point 50a, occurrence of flow reversal at entry point 50a necessarily implies flow reversal at entry point 50c. Such an occurrence is schematized at FIG. 4 with arrows representing the flow of buffer air. Upon such an occurrence, buffer air flows into the deviation path 56 which would normally carry any oil penetrating into the intershaft spacing 62 through the intershaft feed orifice 64 with it rearwardly into the deviation path 56 and potentially into internal cavities or exhaust gasses.

However, in this embodiment, an annular local depression is formed in the internal surface of hollow shaft 120, defining an annular chamber 110 forming an oil trap 112 in the internal shaft cavity 114, at the location of the intershaft feed orifice 64. The annular chamber 110 can work in cooperation with the centrifugal action imparted to the reversed flow by the high velocity rotation of the hollow shaft 120 to trap oil 116 and allow the trapped oil 116 to re-enter the entry point 50a through the intershaft feed orifice 64, and thence return into the bearing cavity 40 via the bearing seal 42a and bearing 31a when normal operation resumes, in which case the intershaft feed orifice 64 acts as oil recuperation orifice 64a. More particularly, the hollow shaft 120 can be said to have a wall 118 with an internal shaft cavity 114 therein and which houses, in this embodiment, an inner shaft 122. The wall 118 has an external surface 124 and an internal surface 126, and can be provided with a plurality of annularly interspaced oil recuperation orifices 64a extending there across, for instance. The local depression is formed in the internal surface 126 of the hollow shaft 120 and has a collector portion 140 axially terminated by a ridge 128 which protrudes radially inward from the collector portion 140 into the internal shaft cavity 114, adjacent the oil recuperation orifices 64a and delimits the oil trap 112 such that in the event of a reversed flow of buffer air leading toward the deviation path 56 rearwardly of the oil recuperation orifice 64a, oil droplets are both carried radially outward against the inner surface 126 of the wall 118 of the hollow shaft 120, and toward the deviation path 56 by the reversed flow of air 130, but the droplets of oil which have accumulated in the oil trap are prevented from travelling rearwardly by the stopping action of the annular ridge 128. In this embodiment, the intershaft feed orifice 64 extends across the wall 118 and connects the collector portion 140 of the oil trap. The intershaft feed orifice 64 is positioned immediately adjacent the ridge 128, favouring a guiding action of the ridge 128 guiding the oil to the collector portion 140 of the oil trap. In this embodiment, the ridge 128 is in the form of a planar annular wall portion which is oriented radially, and normal to the collector portion 140, though the particular configuration and orientation illustrated herein can vary in alternate embodiments. The ridge 128 axially terminates the collector portion 140 at an axial end 142 of the oil trap 112 adjacent the deviation path 56. In this embodiment, an annular sloping portion 144 which slopes radially inward from the collector portion 140 is also provided at the other axial end 146 of the oil trap, opposite the ridge 128 and the deviation path 56, though this sloping portion 144 is optional and can be omitted in alternate embodiments. The oil trap 112 can accumulate oil 116 during the reversed flow conditions at bearing seal 42a. The oil 116 can re-enter the bearing cavity 40 when normal flow conditions return, the oil 116 then being entrained through the bearing seal 42a and the bearing 31a and into the bearing cavity 40.

In this embodiment, as detailed above, during conditions of flow reversal at bearing seal 42a, flow reversal also occurs at bearing seal 42c. Oil leaking from bearing seal 42c can be carried by outwardly by centrifugal action imparted by the rotation of the hollow shaft 120 and rearwardly by the reversed flow of air 130 and eventually be collected in the oil trap 112 in a manner similar to that detailed above in relation with oil leaking from bearing seal 42a.

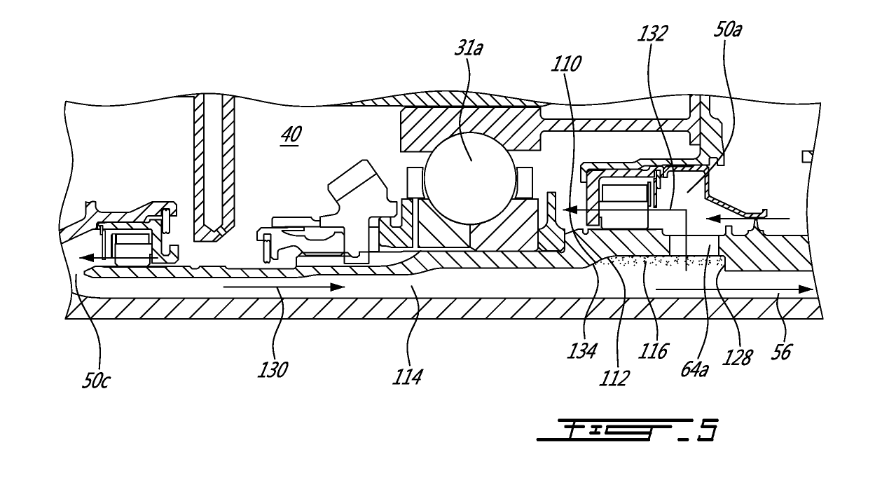

In this embodiment, as detailed above, the conditions of flow can return to normal at entry point 50a while conditions of flow reversal can continue at entry point 50c. This situation is shown in FIG. 5. In this situation, oil leaking from bearing seal 42c is carried rearwardly by reversed flow 130 and eventually moves into the oil trap 112 as detailed above, but will likely not accumulate in the oil trap 112, rather re-entering the bearing cavity 40 via entry point 50a in a continuous manner, carried by the normal flow 132 of buffer air into the bearing cavity 40. Also best seen in FIG. 5, the oil trap 112 in this embodiment not only includes an annular ridge 128 terminating one axial end thereof, but also includes a truncated conical surface 134 terminating the other axial end thereof and completing an annular chamber 110. The presence of the truncated conical surface 134 is optional. The shape of the oil trap 112 can vary in alternate embodiments.

The above description is meant to be exemplary only, and one skilled in the art will recognize that changes may be made to the embodiments described without departing from the scope of the invention disclosed. For example, the teachings can be applied to gas turbine engine types other than turbofan engines. Alternate embodiments can be applied to gas turbine engines having a single shaft instead of two shafts, for instance in which case a deviation path can be provided in a single hollow shaft, for instance, and to bearing cavities having a different number of bearings, a different number of seals, etc., for instance. Still other modifications which fall within the scope of the present invention will be apparent to those skilled in the art, in light of a review of this disclosure, and such modifications are intended to fall within the scope of the appended claims.

What is claimed is:

1. A gas turbine engine having an annular gas path between a radially outer wall and a radially inner wall, leading successively across at least one compressor stage, a combustor section, and at least one turbine stage, the gas turbine engine comprising:
a hollow shaft having a wall with an internal shaft cavity therein, the wall having an external surface and an internal surface, the internal surface having a local depression forming having a collector portion terminated axially by a ridge protruding radially-inwardly from the collector portion and forming an oil trap, and at least one oil recuperation orifice extending across the wall and connecting the collector portion of the oil trap;
a deviation path providing fluid flow communication between the internal shaft cavity and the gas path and being distinct from the oil recuperation orifice;
a bearing cavity formed within the radially inner wall, having at least one bearing therein rotatably supporting the hollow shaft of the gas turbine engine, at least two bearing seals enclosing the at least one bearing in the bearing cavity and separating the bearing cavity from associated buffer air entry points, and at least one scavenge line inlet in the bearing cavity;
an oil supply system including oil paths leading to each of the bearings;
a buffer air supply system including buffer air paths leading to each of the entry points;
at least a first one of said buffer air entry points being in fluid flow communication with the oil trap of the internal shaft cavity via the at least one oil recuperation orifice.

2. The gas turbine engine of claim 1 wherein the local depression is annular, the ridge is oriented radially and normal to the collector portion, and whereby, during use, oil inside the internal shaft cavity can become trapped in the oil trap and prevented from entering the deviation path by centrifugal action imparted by the rotation of the hollow shaft, to re-enter the bearing cavity via the oil recuperation orifice and the first entry point.

3. The gas turbine engine of claim 1, wherein the buffer air supply has a connecting air path extending from the first entry point to the second entry point via the internal shaft cavity.

4. The gas turbine engine of claim 3 wherein the deviation path extends along the internal shaft cavity of the hollow shaft beginning from a location adjacent to the oil trap, and extending away from the oil trap.

5. The gas turbine engine of claim 4 wherein the oil recuperation orifice causes a flow restriction in the buffer air supply reducing the flow rate of buffer air from the first entry point to the second entry point, thereby establishing a higher relative pressure at the first entry point.

6. The gas turbine engine of claim 1 wherein the gas turbine engine has an inner shaft extending across the internal shaft cavity of the hollow shaft and spaced therefrom by an intershaft spacing, and the deviation path extends along the intershaft spacing rearwardly of the oil trap.

7. The gas turbine engine of claim 6 further comprising a second entry point at a gap between an end of the hollow shaft and the inner shaft, the second entry point being associated with a corresponding bearing and bearing seal.

8. The gas turbine engine of claim 7, wherein the buffer air supply has a connecting air path extending from the first entry point to the second entry point along a portion of the intershaft spacing.

9. The gas turbine engine of claim 8 wherein the oil recuperation orifice causes a flow restriction in the buffer air supply reducing the flow rate of buffer air from the first entry point to the second entry point, thereby establishing a higher relative pressure at the first entry point.

10. The gas turbine engine of claim 1 further comprising a baffle arrangement separating a subchamber of the first entry point, said subchamber being exposed to the associated bearing seal and the at least one oil recuperation orifice, said baffle arrangement being operational upon flow reversal across the associated bearing seal to guide fluid coming into the subchamber from the bearing seal through the oil recuperation orifice.

11. The gas turbine engine of claim 10 wherein the baffle arrangement includes a baffle and a lab seal protruding between the baffle and the at least one shaft.

12. The gas turbine engine of claim 10 wherein the subchamber includes an outer gutter.

13. The gas turbine engine of claim 12 wherein the outer gutter is formed at least partially by a baffle having an axially sloping portion.

14. The gas turbine engine of claim 10 wherein the subchamber includes an inner gutter formed in the at least one shaft.

15. The gas turbine engine of claim 14 wherein the inner gutter includes an annular outward protrusion formed in the at least one shaft.

16. The gas turbine engine of claim 15 wherein the annular outward protrusion is radially aligned with an axially sloping portion of a baffle at least partially forming an outer gutter.

17. The gas turbine engine of claim 16 wherein the baffle arrangement includes a lab seal protruding outwardly between said at least one shaft and the baffle, and positioned adjacent the annular outward protrusion.

18. The gas turbine engine of claim 10, wherein the first entry point is further in fluid flow communication with an associated secondary path leading to the portion of the gas path upstream of the bleed air aperture, the baffle arrangement separating the subchamber from the associated secondary path.

19. A gas turbine engine having an annular gas path between a radially outer wall and a radially inner wall, leading successively across at least one compressor stage, a combustor section, and at least one turbine stage, the gas turbine engine comprising:
a hollow shaft having an internal surface with an oil trap formed therein as a local depression axially terminated by a radially-inward extending ridge, and at least one oil recuperation orifice extending out across the hollow shaft from the oil trap; and
a bearing cavity formed within the radially inner wall, having at least one bearing therein rotatably supporting the hollow shaft of the gas turbine engine, at least two bearing seals enclosing the at least one bearing in the bearing cavity and separating the bearing cavity from associated buffer air entry points, at least a first one of said buffer air entry points being exposed to the at least one oil recuperation orifice outside the hollow shaft.

20. The gas turbine engine of claim 19 wherein the oil trap is in the form of an annular internal chamber.
